(19) United States
(12) Patent Application Publication
(10) Pub. No.: US 2012/0011999 A1
(43) Pub. Date: Jan. 19, 2012

(54) METHOD AND SYSTEM FOR REMOVING PARTICULATES FROM A FLUID STREAM

(76) Inventor: Simon Charles Larcombe, Alton (GB)

(21) Appl. No.: 12/838,191

(22) Filed: Jul. 16, 2010

(51) Int. Cl. B01D 53/14

(52) U.S. Cl. 95/10; 96/361; 95/214; 95/187; 96/240

(57) ABSTRACT

A method and systems for collecting particulates suspended in a fluid flowing through a duct are provided. The system includes a duct including an inlet opening configured to admit a flow of gas into the duct, during operation the gas including particulate contaminants and moisture and a source of hydrophobizing agent coupled in flow communication with the duct. The system also includes a nozzle configured to channel a flow of the hydrophobizing agent into the flow of gas such that during operation a flow of gas including hydrophobized particulate contaminants and moisture is formed and a filter medium for separating the hydrophobized particles from the flow of gas.

### BACKGROUND OF THE INVENTION

The field of the invention relates generally to removing particulate matter from a stream of gas or other fluid, and more specifically, to an apparatus and method for removing hydrophobized particles from a stream of fluid.

Fabric filtration is a common technique for separating out particulate matter in a gas stream before entering a gas turbine engine. In an industrial setting, fabric filtration is often accomplished in a device known as a filter house. Generally, a filter house includes a housing that has an inlet for receiving dirty, particulate-ladened gas and an outlet through which clean gas leaves the filter house before entering a use apparatus, such as, but not limited to, a gas turbine engine. The interior of the housing is divided by a tube sheet separating the dirty unfiltered gas from the clean filtered gas. The tube sheet typically includes a number of apertures and supports a number of filter elements with each filter element covering one of the apertures.

In operation, particulate-ladened or dirty gas is conveyed into the filter house, and more specifically into the dirty gas plenum, through the inlet. The gas then flows through the fabric filter media to the interior space within the filter cartridge. As the gas flows through the filter media, the particulate matter carried by the gas engages the exterior of the filter media and either accumulates on the filters or falls to the lower portion of the dirty side gas plenum. Thereafter, the cleaned gas flows through the apertures in the tube sheet and into the clean gas plenum. The clean gas then flows out of the filter house.

However, when the air entering the inlet duct is also wet, such as when it is located in a marine or coastal environment or when the weather is rainy, misty, or includes high humidity, the effectiveness of the pulse cleaning system is significantly reduced. The dust and moisture mix become a sticky mass that is difficult to remove by a pulse cleaning system. This in turn leads to a rapid increase in differential pressure (ΔP) across the filter media, which cannot be reduced significantly by pulsing. Also if the air temperature drops to near freezing the wet, sticky dust turns solid again leading to rapid filter blockage.

### BRIEF DESCRIPTION OF THE INVENTION

In one embodiment, a system for collecting particulates suspended in a fluid flowing through a duct includes a duct including an inlet opening configured to admit a flow of gas into the duct, during operation the gas including particulate contaminants and moisture and a source of hydrophobizing agent coupled in flow communication with the duct. The system also includes a nozzle configured to channel a flow of the hydrophobizing agent into the flow of gas such that during operation a flow of gas including hydrophobized particulate contaminants and moisture is formed and a filter medium for separating the hydrophobized particles from the flow of gas.

In another embodiment, a method of collecting particulates suspended in a moisture-containing fluid flowing through a duct includes mixing the particulates suspended in the fluid flowing through the duct with a flow of hydrophobizing agent in the duct such that at least a portion of the flow of hydrophobizing agent combines with at least some of the particles. The method also includes conveying the hydrophobized particles to a filter media and separating the hydrophobized particles from the fluid using the filter media.

In yet another embodiment, a particulate filtration system for removing particles suspended in a flow of fluid includes a duct including a hydrophobizing agent spray and recirculation system, a filter media in the duct downstream from the hydrophobizing agent spray, and a reverse flow pulse cleaning system operatively coupled to the filter media.

### BRIEF DESCRIPTION OF THE DRAWINGS

FIG. 1-2 show exemplary embodiments of the method and systems described herein.

The foregoing and other features and aspects of the invention will be best understood with reference to the following description of certain exemplary embodiments of the invention, when read in conjunction with the accompanying drawings, wherein:

FIG. 1 is a schematic block diagram of an inlet filter system in accordance with an exemplary embodiment of the present invention; and

FIG. 2 is a flow diagram of a method of collecting particulates suspended in a fluid flowing through a duct in accordance with an exemplary embodiment of the present invention.

### DETAILED DESCRIPTION OF THE INVENTION

The following detailed description illustrates embodiments of the invention by way of example and not by way of limitation. It is contemplated that the invention has general application to analytical and methodical embodiments of providing a cleaned flow of fluid reliably in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

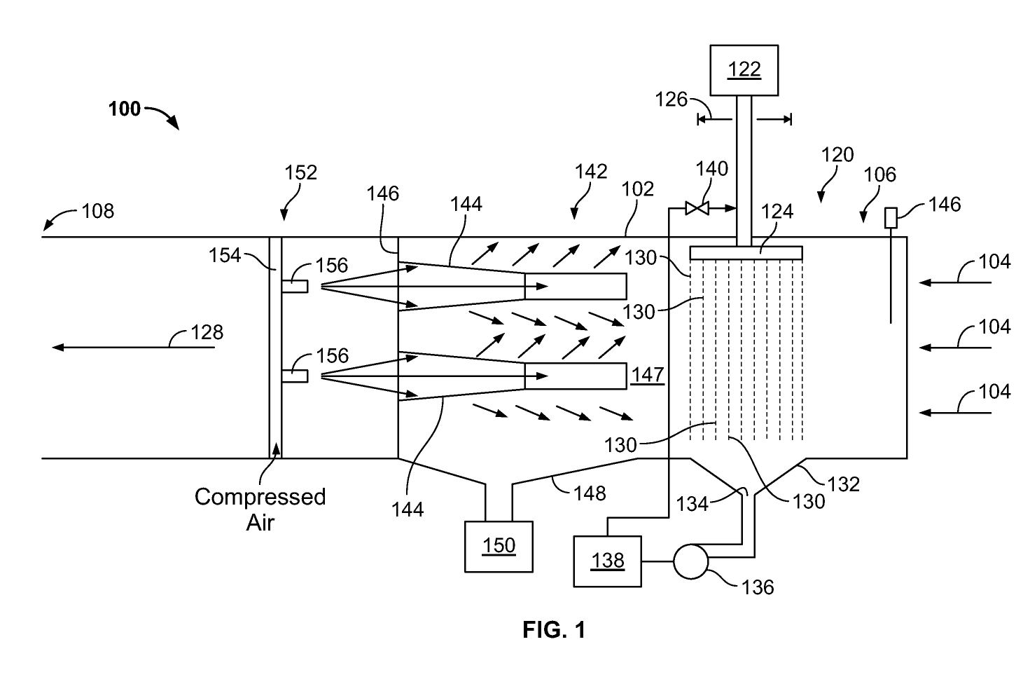

FIG. 1 is a schematic block diagram of an inlet filter system 100 in accordance with an exemplary embodiment of the present invention. In the exemplary embodiment, system 100 includes a duct 102 configured to convey a flow 104 of fluid from an inlet 106 to an outlet 108. In the exemplary embodiment, flow 104 comprises a dust and moisture ladened air stream.

In the exemplary embodiment, duct 102 includes a silicon-based wet scrubber system, such as hydrophobizing agent injection section 120. Hydrophobizing agent injection section 120 includes a source 122 of hydrophobizing agent, such as, but not limited to, a silicone based solution. Source 122 is coupled in flow communication to a flow distribution header 124 that may include a plurality of sub-branches (not shown) to deliver a flow of hydrophobizing agent evenly across duct 102 for a predetermined axial length 126 in a direction 128 of flow 104 through a plurality of nozzles 130. Hydrophobizing agent injection section 120 includes a hydrophobizing agent collection hopper 132 positioned below header 124 to receive excess hydrophobizing agent that passes through flow 104. At least some of the hydrophobizing agent may interact with the particulates in flow 104 and carry the particulates out of flow 104 and into hopper 132. Hopper 132 includes an opening 134 coupled in flow communication to a suction of a recirculation pump 136. Pump 136 may discharge through a hydrophobizing agent cleanup system 138 before pumping the collected hydrophobizing agent back to nozzles 130. A flow control valve 140 may be used to maintain a predetermined level in hopper 132.

A filter section 142 is positioned downstream from hydrophobizing agent injection section 120. In the exemplary embodiment, filter section 142 includes a plurality of filter media 144 extended through a tubesheet 146 in a direction opposite direction 128. Hydrophobized particles in flow 104 are conveyed from hydrophobizing agent injection section 120 to an inlet 147 to filter section 142 where the hydrophobized particles are separated from flow 104 by filter media 144. Because the particles are hydrophobized, any water or moisture in flow 104 does not “wet” the particles and substantially dry particles are collected by filter media 144. Dry particles tend not to cake and adhere to a surface of filter media 144, but rather the dry particles tend to separate easily from each other and from filter media 144. Filter section 142 includes a particulate collection hopper 148 that receives the collected particles and stores them for disposal using a particle removal system 150.

A pulse cleaning system 152 is positioned downstream from filter section 142. In the exemplary embodiment, pulse cleaning system 152 includes a header 154 and a plurality of cleaning nozzles 156, usually one cleaning nozzle per filter media 144. A relatively particulate-free flow 104 exits duct 102 through outlet 108.

In operation, hydrophobizing agent injection section 120 is installed upstream of filter section 142 of, for example, a gas turbine engine. Silicone is used as hydrophobizing agent as shown, but other hydrophobizing agents may be used in place of silicone. Hydrophobizing agent injection section 120 includes a series of spray nozzles 130 that spray a fine mist of silicon particles into flow 104. These relatively small particles of silicon come into contact with any dust particle contamination in the air and coat them. Relatively larger particles of dust and dust that is at least partially coated with the hydrophobizing agent tend to fall into hopper 132 because of the increase in their mass and are collected for disposal. Clean silicon then recycled and fed back into hydrophobizing agent injection section 120.

The coated dust particles that have a mass/surface area ratio small enough that they don't fall out of flow 104 in hydrophobizing agent injection section 120 travel in flow 104 until they enter filter section 142 and are captured in filter media 144. The dust particles are larger in size after having been coated by the hydrophobizing agent leading to more efficient filtration performance and are also now resistant to any water present in flow 104.

When pulse cleaning system 152 is activated, a blast of air from cleaning nozzles 156 is then able to remove the small non-stick dust particles from filter media 144, where they fall into hopper 148 for collection and disposal. Similarly, even in cold weather conditions when the water and dust freeze, they will remain separate from each other ensuring pulse cleaning system 152 can remain more effective.

It could also be expected that any free silicon droplets from hydrophobizing agent injection section 120 that are very small in mass will be drawn into filter media 144 and act to increase the hydrophobic properties of the media itself thus increasing the pulse system effectiveness for the duration of the filters life.

In one embodiment, hydrophobizing agent injection section 120 is activated based on an amount of moisture determined in flow 104. For example, hydrophobizing agent injection section 120 may be only activated if there is determined to be water present in flow 104 or when a temperature of flow 104 exceeds a predetermined range, such as, but not limited to less than about 4.0 degrees centigrade or a temperature determined to facilitate a formation of ice. In the embodiment, a weather sensor 146, for example, but not limited to a rain gauge, a moisture or humidity sensor, and/or a temperature sensor are used alone or in combination to facilitate determining the activation point for hydrophobizing agent injection section 120.

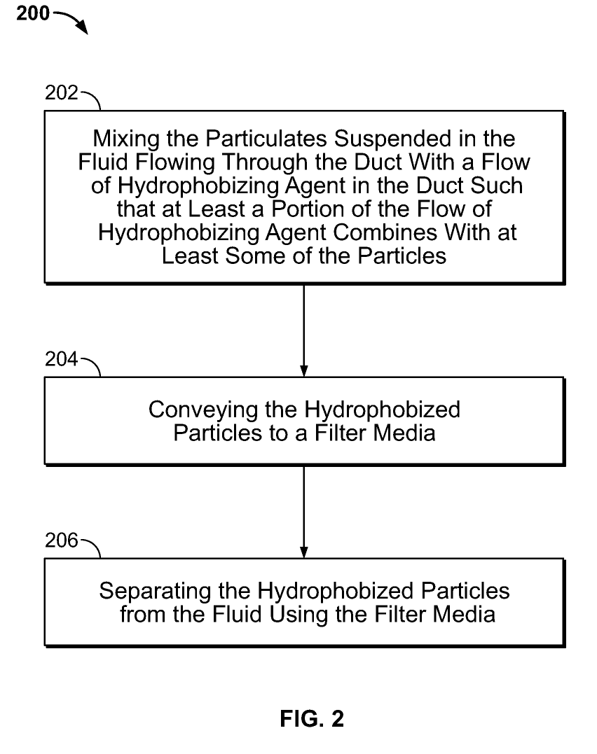

FIG. 2 is a flow diagram of a method 200 of collecting particulates suspended in a fluid flowing through a duct in accordance with an exemplary embodiment of the present invention. In the exemplary embodiment, the method includes mixing 202 the particulates suspended in the fluid flowing through the duct with a flow of hydrophobizing agent in the duct such that at least a portion of the flow of hydrophobizing agent combines with at least some of the particles, conveying 204 the hydrophobized particles to a filter media, and separating 206 the hydrophobized particles from the fluid using the filter media.

The above-described embodiments of a method and system of collecting particulates suspended in a flow of fluid provides a cost-effective and reliable means of passing any contaminates through a silicon-based wet scrubber system, before being captured by a filter media. The contaminates and water are prevented from mixing together to form a wet sticky mixture by making the contaminates hydrophobic in the wet scrubber. Hydrophobizing the particles prevents the formation of a wet sticky dust cake on the filter media surface that can not be effectively pulsed off of the filter media. More specifically, the method and system described herein facilitate significantly improve the pulse cleaning system effectiveness in wet or humid and/or cold weather conditions. Making the dust contamination hydrophobic facilitates maintaining a relatively low ΔP across the filter media. In addition, the above-described method and system facilitate extension of a filter media's useful life. Extended filter life not only saves the cost of filters, it also saves the cost of filter replacement, which is often difficult, costly, and requires the filter house to be taken out of service for a period of time. As a result, the method and system described herein facilitate efficiently removing particulate matter form of flow of fluid when moisture is present and permitting easier removal of the particles collected on the filter media in a cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An inlet filter system comprising:
a duct comprising an inlet opening configured to admit a flow of gas into said duct, during operation said gas including particulate contaminants and moisture;
a source of hydrophobizing agent coupled in flow communication with said duct;
a nozzle configured to channel a flow of the hydrophobizing agent into the flow of gas such that during operation a flow of gas including hydrophobized particulate contaminants and moisture is formed; and
a filter medium for separating the hydrophobized particles from the flow of gas.

2. An inlet filter system in accordance with claim 1, further comprising a spray header comprising a plurality of nozzles including said nozzle.

3. An inlet filter system in accordance with claim 2, wherein said plurality of nozzles channel the flow of hydrophobizing agent into the flow of gas.

4. An inlet filter system in accordance with claim 1, further comprising a hydrophobizing agent recirculation system coupled in flow communication with said duct.

5. An inlet filter system in accordance with claim 1, wherein said hydrophobizing agent recirculation system is configured to:
receive a flow of excess hydrophobizing agent from said duct; and
channel the received excess hydrophobizing agent to said nozzle.

6. An inlet filter system in accordance with claim 1, wherein the hydrophobic particles are collected using a disposal system coupled in flow communication with said duct.

7. An inlet filter system in accordance with claim 1, further comprising a weather sensor configured to activate a flow of hydrophobizing agent from said source of hydrophobizing agent.

8. A method of collecting particulates suspended in a moisture-containing fluid flowing through a duct, said method comprising:
mixing the particulates suspended in the fluid flowing through the duct with a flow of hydrophobizing agent in the duct such that at least a portion of the flow of hydrophobizing agent combines with at least some of the particles;
conveying the hydrophobized particles to a filter media; and
separating the hydrophobized particles from the fluid using the filter media.

9. A method in accordance with claim 8, wherein mixing the particulates suspended in the moisture-containing fluid flowing through the duct with a flow of hydrophobizing agent in the duct comprises spraying a mist of hydrophobizing agent into the duct.

10. A method in accordance with claim 9, wherein spraying a mist of hydrophobizing agent into the duct comprises spraying a mist of hydrophobizing agent orthogonally into the duct with respect to a direction of flow of the moisture-containing fluid flowing through the duct.

11. A method in accordance with claim 8, wherein separating the hydrophobized particles from the moisture-containing fluid using the filter media comprises collecting the separated hydrophobized particles using a disposal system.

12. A method in accordance with claim 8, wherein mixing the particulates suspended in the moisture-containing fluid flowing through the duct with a flow of hydrophobizing agent in the duct comprises at least one of adsorbing and absorbing the hydrophobizing agent to the at least some of the particles.

13. A method in accordance with claim 8, further comprising collecting an excess of hydrophobizing agent using a recycle system.

14. A method in accordance with claim 13, further comprising channeling the collected excess hydrophobizing agent to the duct using the recycle system.

15. A method in accordance with claim 8, further comprising activating the flow of hydrophobizing agent based on at least one of an amount of moisture in the moisture-containing fluid flowing through the duct and a temperature of the moisture-containing fluid flowing through the duct.

16. A particulate filtration system for removing particles suspended in a flow of fluid, said system comprising:
a duct comprising a hydrophobizing agent spray and recirculation system;
a filter media in said duct downstream from said hydrophobizing agent spray; and
a reverse flow pulse cleaning system operatively coupled to said filter media.

17. A system in accordance with claim 16, wherein said hydrophobizing agent spray system comprises a nozzle coupled in flow communication with a source of hydrophobizing agent.

18. A system in accordance with claim 16, wherein said recirculation system comprises an excess hydrophobizing agent collector coupled in flow communication with said duct and a pump coupled in flow communication between said collector and said nozzle.

19. A system in accordance with claim 16, further comprising a particulate collection system coupled in flow communication with said duct.

20. A system in accordance with claim 16, wherein said hydrophobizing agent comprises silicone.
